(19) United States
(12) Patent Application Publication
(10) Pub. No.: US 2026/0133168 A1
(43) Pub. Date: May 14, 2026

(54) METHOD FOR DETECTING POLYHEXAMETHYLENE BIGUANIDE HYDROCHLORIDE IN TEXTILES

(71) Applicants: Shenzhen Customs Industrial Products Testing Technology Center, Shenzhen (CN); Tan Kah Kee Innovation Laboratory, Xiamen (CN)

(72) Inventors: Chengfa LI, Shenzhen (CN); Weiya ZHANG, Shenzhen (CN); Tangtang XIE, Xiamen (CN); Yanhua LI, Shenzhen (CN); Junfeng LIN, Shenzhen (CN); Shengyang ZHONG, Shenzhen (CN)

(73) Assignees: Shenzhen Customs Industrial Products Testing Technology Center, Shenzhen (CN); Tan Kah Kee Innovation Laboratory, Xiamen (CN)

(21) Appl. No.: 19/437,353

(22) Filed: Dec. 31, 2025

(30) Foreign Application Priority Data
Nov. 7, 2024 (CN) 2024115802846

(51) Int. Cl. G01N 30/88; B01D 15/42; B01D 69/02; B01D 71/36; G01N 1/40; G01N 30/02; G01N 30/86

(52) U.S. Cl. CPC G01N 30/88; B01D 15/426; B01D 69/02; B01D 71/36; G01N 1/4077; G01N 30/8624; B01D 2325/02834; G01N 2001/4088; G01N 2001/4094; G01N 2030/027; G01N 2030/884

(57) ABSTRACT

This application relates to the technical field of chemical detection, and in particular, to chemical detection of textiles, and more specifically, provides a method for detecting polyhexamethylene biguanide hydrochloride in textiles. The method employs ultrasonic extraction for sample pretreatment, and optimizes chromatographic conditions in HPLC analysis to detect the content of the polyhexamethylene biguanide hydrochloride in a textile. The detection method of this application enables easy, accurate, and sensitive determination of the content of the polyhexamethylene biguanide hydrochloride in textiles and facilitates quality control of textile products, thereby effectively ensuring smooth export of textile products.

### CROSS-REFERENCE TO RELATED APPLICATIONS

The application claims priority to Chinese patent application No. 2024115802846, filed on Nov. 7, 2024, the entire contents of which are incorporated herein by reference.

### TECHNICAL FIELD

This application relates to the technical field of chemical testing of textiles, and in particular, to a method for detecting polyhexamethylene biguanide hydrochloride (PHMB) in textiles.

### BACKGROUND

PHMB is a broad-spectrum antimicrobial agent. Characterized by extremely high bactericidal activity, broad-spectrum high efficacy, high water solubility, and odorless and tasteless aqueous solution, the PHMB is widely used in various fields such as textiles, cosmetics, and disinfectants. The PHMB is positively charged and can mutually adsorb negatively charged microorganisms to block microbial respiratory channels and inhibit proliferation of bacteria and viruses. A biguanide groups can also bind to the phosphatidylglycerol bilayer on a bacterial surface to disrupt the bilayer and increase cell membrane fluidity and permeability, and ultimately lead to bacterial lysis and death. The impact of the PHMB on cell membranes also exists in mammalian cells. The PHMB ingested through food, water, or skin contact may pose health hazards to humans. As early as the 1970s, ICI in the United States first prepared PHMB. In 2011, the European Chemicals Agency (ECHA) identified PHMB as a suspected carcinogen. In 2013, EU Regulation No. 944 classified PHMB as a carcinogenic, mutagenic, and reprotoxic (CMR2) substance. In the same year, the EU Biocidal Products Regulation (BPR) 528 came into effect, listing PHMB under regulatory control. In 2017, the European Commission lowered the limit for PHMB in the former Cosmetics Regulation 1223 from 0.3% to 0.1% and prohibited the use of PHMB in products that may make end users inhale or be exposed to PHMB. In April 2021, the EU RAPEX reported a PHMB-containing and antimicrobial-treated polyester fabric mask (Alert No.: A12/00538/21), stating that inhalation of PHMB is harmful and may cause allergic reactions of skin. Inhalation of or repeated exposure to PHMB may damage organs and is also suspected of being carcinogenic.

In textiles, PHMB is mainly used as an antimicrobial and deodorizing finishing agent. Fabrics treated with PHMB are primarily used to manufacture underwear, socks, masks, and other products. The PHMB may enter the human body through food, water, inhalation, skin contact, or by other means, and may pose carcinogenic, mutagenic, reprotoxic and other hazards to the human body. Currently, regulations on PHMB primarily focus on disinfectants, cosmetics, toy dyes, and the like, and no standards or literatures are available at home and abroad for detecting PHMB in textiles. To respond promptly to international regulations, improve market supervision, meet enterprise quality control requirements, and protect consumer health, it is urgent to establish a method for analyzing PHMB in textiles.

Existing PHMB detection methods focus on disinfectant products, and include ultraviolet spectrophotometry and capillary electrophoresis. A review of published international papers reveals that other main detection methods in addition to the above two methods include high-performance liquid chromatography (HPLC), ultra-high-performance liquid chromatography-quadrupole time-of-flight mass spectrometry (UHPLC-QTOF-MS), and the like. These methods are primarily applied to the detection of PHMB in disinfectants, eyeglass care solutions, swimming pool water, eye drops, and other products. However, no method for detecting PHMB in textiles is currently available.

The textile industry is a pillar industry of China and an important export-oriented sector, exerting a significant influence on the national economy. The European Union is a major export market of textiles. Establishing a standard for the determination of PHMB content in light textile products is of great significance for meeting new international requirements, overcoming foreign technical barriers, and ensuring the smooth export of China's textile products.

### SUMMARY

An objective of this application is to disclose a method for easily, accurately and sensitively detecting PHMB in textiles to overcome the deficiency in the prior art that lacks a method for detecting PHMB in textiles.

To achieve the above objective, a technical solution of this application provides a method for detecting PHMB in textiles. The method includes the following steps:
(1) sample pretreatment: adding a textile under test into an extraction solvent, and performing ultrasonic extraction and filtration to obtain a sample test solution; and
(2) high-performance liquid chromatography detection: analyzing the sample test solution under the following chromatographic conditions to obtain a chromatogram, and determining a content of the PHMB in the textile through analytical chemistry calculation based on the chromatogram.

In some embodiments, in step (1), an extraction solvent used in the ultrasonic extraction includes an ammonium chloride solution and methanol. The pH value of the ammonium chloride solution is adjusted using hydrochloric acid. Preferably, a concentration of the ammonium chloride solution is 0.5 mol/L to 2.0 mol/L, a volume fraction of the ammonium chloride solution is 20% to 70%, and the pH value of the ammonium chloride solution is 1.0 to 3.0. More preferably, the concentration of the ammonium chloride solution is 1.8 mol/L, the volume fraction of the ammonium chloride solution is 40%, and the pH value of the ammonium chloride solution is 1.8.

In some embodiments, the ultrasonic extraction in step (1) is one-time ultrasonic extraction.

In some optional embodiments, a method for the analytical chemistry calculation in step (2) is external standard quantitation. A linear equation of an external standard curve in the external standard quantitation is Y=9536.8x−710.13. Concentration gradients for plotting the external standard curve are 10, 20, 50, 100, and 200 μg/mL.

In some embodiments, the textile under test in step (1) is one or more selected from natural fiber or artificial fiber, and dimensions of the textile under test is 5 mm×5 mm.

In some embodiments, the textile under test in step (1) is one or more selected from cotton, hemp, silk, or polyester.

In some embodiments, the textile under test in step (1) is one or more selected from plant fiber or animal fiber.

In some embodiments, a mass ratio of the textile under test to the extraction solvent in step (1) is 1:(15 to 25), and preferably 1:20.

In some embodiments, an extraction time of the ultrasonic extraction in step (1) is 40 min to 60 min, and preferably 50 min.

In some embodiments, an extraction temperature of the ultrasonic extraction in step (1) is 50° C. to 80° C., preferably 60° C. to 75° C., and more preferably 70° C.

In some embodiments, a volume of an extraction solution for the ultrasonic extraction in step (1) is 15 mL to 35 mL, preferably 19 mL to 30 mL, and more preferably 20 mL.

In some embodiments, a filter membrane used in the filtration in step (1) is an organic filter membrane with a pore size of 0.45 μm, preferably a polytetrafluoroethylene filter membrane, and more preferably a polytetrafluoroethylene filter membrane manufactured by Tianjin Jinteng Experiment Equipment Co., Ltd.

In some embodiments, the high-performance liquid chromatography in step (2) is performed under the following conditions:
chromatographic column: C18 liquid chromatographic column or cyano chromatographic column of 4.6×150 mm and 5 μm or 4.6×75 mm and 3.5 μm in size;
column temperature: 30° C. to 50° C.;
mobile phase A: water;
mobile phase B: aqueous phosphoric acid solution, with a volume fraction 0.1‰ to 1.2‰;
mobile phase C: acetonitrile;
flow rate: 0.8 mL/min to 1.2 mL/min, and preferably 1 mL/min;
elution gradient:
in a time segment from 0 min to 1 min, the elution gradient is: 94% for mobile phase A, 1% for mobile phase B, and 5% for mobile phase C;
in a time segment from 1 min to 12 min, the elution gradient is: 59% for mobile phase A, 1% for mobile phase B, and 40% for mobile phase C;
in a time segment from 12 min to 20 min, the elution gradient is: 0% for mobile phase A, 60% for mobile phase B, and 40% for mobile phase C;
in a time segment from 20 min to 27 min, the elution gradient is: 94% for mobile phase A, 1% for mobile phase B, and 5% for mobile phase C; and
runtime: 27 min.

In some embodiments, a detector used for the detection is DAD, and the detection wavelength is 236 nm.

This application provides a method for detecting PHMB in textiles. The method includes the following steps:
(1) Sample pretreatment: adding a textile under test into an extraction solvent, and performing ultrasonic extraction and filtration to obtain a sample test solution; and
(2) High-performance liquid chromatography detection: analyzing the sample test solution under the following chromatographic conditions to obtain a chromatogram, and determining a content of the PHMB in the textile through analytical chemistry calculation based on the chromatogram.

In step (1), the extraction solvent includes an ammonium chloride solution and methanol, a volume fraction of the ammonium chloride solution is 20% to 70%, a concentration of the ammonium chloride solution is 0.5 mol/L to 2.0 mol/L, and a pH value of the ammonium chloride solution is 1.5 to 4.0.

The chromatographic conditions in step (2) include:
chromatographic column: C18 liquid chromatographic column or cyano chromatographic column of 4.6×150 mm and 5 μm or 4.6×75 mm and 3.5 μm in size;
column temperature: 30° C. to 50° C.;
mobile phase A: water;
mobile phase B: aqueous phosphoric acid solution, with a volume fraction 0.1‰ to 1.2‰;
mobile phase C: acetonitrile;
flow rate: 0.8 mL/min to 1.2 mL/min, and preferably 1 mL/min;
elution gradient:
in a time segment from 0 min to 1 min, the elution gradient is: 94% for mobile phase A, 1% for mobile phase B, and 5% for mobile phase C;
in a time segment from 1 min to 12 min, the elution gradient is: 59% for mobile phase A, 1% for mobile phase B, and 40% for mobile phase C;
in a time segment from 12 min to 20 min, the elution gradient is: 0% for mobile phase A, 60% for mobile phase B, and 40% for mobile phase C;
in a time segment from 20 min to 27 min, the elution gradient is: 94% for mobile phase A, 1% for mobile phase B, and 5% for mobile phase C; and
runtime: 27 min.

In some embodiments, a detector used for the detection is DAD, and the detection wavelength is 236 nm.

Different from the prior art, the technical solution disclosed above establishes a method for detecting PHMB in textiles. Through sample pretreatment and high-performance liquid chromatography detection, this method enables easy, rapid, and accurate acquisition of the content of the PHMB in the textile under test. In this detection method, the limit of detection is 60 mg/kg, and the limit of quantitation (LOQ) is 200 mg/kg. The low limit of detection and the high sensitivity enable the determination of trace amounts of PHMB in textiles. In addition, this method exhibits relatively high precision and accuracy of detection. At three spiking levels (limit of quantitation, five times the limit of quantitation, and ten times the limit of quantitation), an average recovery rate of the PHMB is 90.1% to 100.0%, with a relative standard deviation being 1.09% to 4.31%.

In some embodiments, in the sample pretreatment step, the textile under test is cut into fragments of approximately 5 mm×5 mm in size before use.

In some embodiments, the applicant hereof compares a C18 liquid chromatographic column with a cyano column regarding the effect on retaining and separating the PHMB. It is found that, for the C18 liquid chromatographic columns of different specifications, either the peak elution time of the PHMB is earlier (the chromatographic peak of the PHMB emerges near the solvent peak) or a plurality of peaks emerge, thereby affecting the qualitative and quantitative analysis of the PHMB. For cyano chromatographic columns of three different specifications (250 mm (column length)×4.6 mm (inner diameter)×5 μm (particle size), 150 mm (column length)×4.6 mm (inner diameter)×5 μm (particle size), and 75 mm (column length)×4.6 mm (inner diameter)×3.5 μm (particle size), the elution behavior of the chromatographic peak is investigated by adjusting different mobile phases and mobile-phase ratios as well as the pH value. It is found that, when a 250 mm chromatographic column is applied, the chromatographic peak shape is inferior; when a 150 mm or 75 mm chromatographic column is applied, a complete chromatographic peak can be obtained.

In some embodiments, the textile is made of cotton, hemp, silk, polyester, or the like.

The detection method disclosed in this embodiment of this application enables easy, accurate, and sensitive determination of the content of the PHMB in textiles and facilitates quality control of textile products, thereby effectively ensuring smooth export of textile products.

### BRIEF DESCRIPTION OF DRAWINGS

FIG. 1 shows how a volume fraction (%) of ammonium chloride in an extraction solution affects performance of extraction from positive samples according to Embodiment 1, where the extraction solution is formed of an ammonium chloride solution and methanol;

FIG. 2 shows how a concentration (mol/L) of an ammonium chloride solution in an extraction solution affects performance of extraction from positive samples according to Embodiment 1, where the extraction solution is formed of an ammonium chloride solution and methanol;

FIG. 3 shows how a pH value of an ammonium chloride solution in an extraction solution affects performance of extraction from positive samples according to Embodiment 1, where the extraction solution is formed of an ammonium chloride solution and methanol;

FIG. 4 shows how an extraction time affects performance of extraction from positive samples according to Embodiment 1;

FIG. 5 shows how an extraction temperature affects an extraction yield according to Embodiment 1;

FIG. 6 shows a spectrogram of a PHMB standard solution according to Embodiment 1;

FIG. 7 shows impact of a volume fraction of phosphoric acid in a mobile-phase aqueous phosphoric acid solution according to Embodiment 1;

FIG. 8 shows an HPLC chromatogram of a PHMB standard solution according to Embodiment 1; and

FIG. 9 shows an HPLC chromatogram of an actual sample according to Embodiment 1.

### DETAILED DESCRIPTION OF THE EMBODIMENTS

For ease of understanding, this application is described more comprehensively below, and preferred embodiments of this application are described below. However, this application may be implemented in many different forms without being limited to the embodiments described herein. Rather, such embodiments are provided to enable a more thorough and comprehensive understanding of the disclosure of this application. Unless techniques or conditions are otherwise expressly specified in an embodiment hereof, the techniques or conditions described in the literature in this field or in an instruction manual of the product are applicable in the embodiment. A reagent or instrument used herein without specifying a manufacturer is a conventional product that is commercially available in the market.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein includes any and all combinations of one or more relevant items enumerated.

The detection instruments used in this application include: liquid chromatograph (LC-20AD, Shimadzu Corporation, Japan), equipped with a quaternary pump and a diode array detector (DAD); electronic balance (CPA324S, Sartorius, Germany); ultrasonic extractor (SB25-12DT, Ningbo Scientz Biotechnology Co., Ltd.); 50 mL stoppered glass extractor, tubular; 0.45 μm polytetrafluoroethylene filter membrane, 13 mm in diameter, by Tianjin Jinteng Experiment Equipment Co., Ltd.

The reagents used in this application include: PHMB standard, with a purity of 97.2%, purchased from Dr. Ehrenstorfer, Germany; hydrochloric acid (analytical grade), at a content 36% to 38%, with a density of 1.19 g/mL, purchased from Dongguan Dongjiang Chemical Reagent Co., Ltd.; ammonium chloride (analytical grade), purchased from Sinopharm Group Chemical Reagent Co., Ltd.; ammonia water (HPLC grade), at a content greater than or equal to 25%, with a density of 0.91 g/mL, purchased from Shanghai Anpu Experimental Technology Co., Ltd.; phosphoric acid (HPLC grade), at a content of 85%, with a density of 1.69 g/mL, purchased from ANPEL Laboratory Technologies (Shanghai) Inc.; acetonitrile (HPLC grade), purchased from ANPEL Laboratory Technologies (Shanghai) Inc.

The solutions used in this application are prepared using the following method:

Preparation of an ammonium chloride solution (1.8 mol/L, pH 1.8): Weighing out 24.07 grams of ammonium chloride, dissolving the ammonium chloride in water, transferring the solution to a 250 mL volumetric flask, and diluting the solution to the mark with water. Transferring the solution to a 500 ml beaker, and adjusting the pH value to 1.8 using hydrochloric acid.

Preparation of extraction solution: Transferring 100 mL of ammonium chloride solution into a 250 mL volumetric flask accurately, and diluting the solution to the mark with methanol.

Preparation of 0.1% phosphoric acid solution (volume fraction): Dissolving 1.0 mL of phosphoric acid in 1000 mL of first-grade water.

Preparation of standard stock solution: Weighing out 100 mg (accurate to the nearest 0.1 mg) of PHMB standard accurately, and diluting with water until a volume of 10 mL to obtain a PHMB stock solution with a mass concentration of 10000 mg/L.

Preparation of intermediate standard solution: Transferring 0.5 mL of the standard stock solution into a 10 mL volumetric flask accurately, and diluting the solution to the mark with an extraction solution to obtain a PHMB intermediate standard solution with a mass concentration of 500 mg/L.

The test samples (positive samples) for use in this application are prepared in the following way:

Preparing positive samples for experiment purposes, in which the extraction conditions are optimized and a commercially available textile (tested as PHMB-free) is used as a substrate. Selecting natural plant fiber (represented by cotton and ramie), natural animal fiber (represented by silk), and synthetic fiber (represented by polyester) separately as a substrate. Preparing 4 positive samples at different PHMB concentrations using an impregnation-baking method, where sample 1 is cotton, sample 2 is ramie, sample 3 is silk, and sample 4 is polyester. Cutting the prepared positive samples into fragments of approximately 5 mm×5 mm in size, and mixing the fragments thoroughly, ready for future use.

### Embodiment 1: Determination of Sample Pretreatment Conditions and Determination of Chromatographic Detection Conditions

A method for detecting PHMB content in textiles is as follows:

### 1.1. Selection of an Extraction Method

Extraction methods for use in the detection of a residual amount of the finishing agent in textiles mainly include: Soxhlet extraction, solid-liquid oscillation extraction, ultrasonic extraction, microwave extraction, accelerated solvent extraction, and the like. Among these methods, Soxhlet extraction is gradually being phased out due to its time-consuming and labor-intensive nature; accelerated solvent extraction is not widely used due to high cost of equipment. Compared with the microwave extraction technique, ultrasonic extraction is simpler to operate. Therefore, to ensure the standardization and operability of the method, this application adopts ultrasonic extraction.

### 1.2 Optimization of Ultrasonic Extraction Conditions

The efficiency of ultrasonic extraction depends on 5 factors: extraction method, type of extraction solvent, extraction time, extraction temperature, and volume of extraction solvent. Therefore, this experiment investigates the 5 factors.

### (1) Selection of an Extraction Solvent

### 1.2.1 Extraction Performance of Different Extraction Solvents

PHMB is readily soluble in water and slightly soluble in lower-alcohol organic solvents. Therefore, in the experiment, the PHMB is extracted from the positive samples of cotton, hemp, silk, and polyester separately using water, methanol, ethanol, isopropanol, and acetonitrile separately. 1 gram of positive sample of cotton, hemp, silk, and polyester is weighed out separately, and is added into 20 mL of water, methanol, ethanol, isopropanol, and acetonitrile, separately. The solution is sonicated at 60° C. for 30 minutes to extract the PHMB. The extraction results are shown in Table 1. Table 1 shows that different extraction solvents differ significantly in the performance of extracting PHMB from the positive samples of cotton, hemp, silk, and polyester. Among the solvents, water is the most effective in extraction of the PHMB from the positive samples of cotton, hemp, and silk, and methanol and ethanol is the most effective in extraction of the PHMB from the positive samples of polyester. The positive samples, from which the PHMB is extracted with water, methanol, and ethanol separately, are filtered. Subsequently, PHMB is further extracted for a second time and a third time from the filter residue using the corresponding water, methanol, and ethanol. The results show that a high content of PHMB is still extracted from the second-time and third-time extractions, indicating that water, methanol, and ethanol are less effective at thoroughly extracting the PHMB. Literature review reveals that cotton, hemp, silk, and polyester contain a significant number of anions. Used as a biguanide cationic surfactant, the PHMB ionizes in an aqueous solution under neutral conditions to form cationic groups. The cationic groups strongly bind to the anions in the cotton, hemp, silk, and polyester, making it very difficult to thoroughly extract the PHMB. With the decrease of the pH value of the solution, the ionization of the PHMB is inhibited, and the strong force of binding with the anions in the cotton, hemp, silk, and polyester weakens. Therefore, in the experiment, a hydrochloric acid solution with a pH value of 2.2 and an ammonium chloride solution with a concentration of 1 mol/L (with the pH adjusted to 2.2 using hydrochloric acid) are used as an extraction solution separately. The results show that the extraction performance of both the hydrochloric acid solution and the ammonium chloride solution is significantly enhanced. For positive samples of cotton, hemp, and polyester, the extraction performance of the ammonium chloride solution is optimal. For positive samples of silk, the extraction performance of the hydrochloric acid solution is optimal. The results are shown in Table 1.

TABLE 1
Impact of different extraction solvents on performance
of extracting PHMB from positive samples

| | Peak area | | | |
|---|---|---|---|---|
| Extraction solvent | Cotton | Hemp | Silk | Polyester |
| Methanol | 977539 | 146673 | 0 | 761132 |
| Ethanol | 108772 | 0 | 0 | 756539 |
| Isopropanol | 24715 | 0 | 0 | 410222 |
| Acetonitrile | 0 | 0 | 0 | 50062 |
| Water | 944525 | 424058 | 10722 | 418101 |
| Hydrochloric acid | 2174475 | 1579251 | 551943 | 892150 |
| solution (pH 2.2) | | | | |
| 1 mol/L ammonium | 2388840 | 1623930 | 245802 | 984552 |
| chloride solution | | | | |
| (pH 2.2) | | | | |

### 1.2.2 Impact of Volume Fraction of Ammonium Chloride Solution in an Extraction Solution

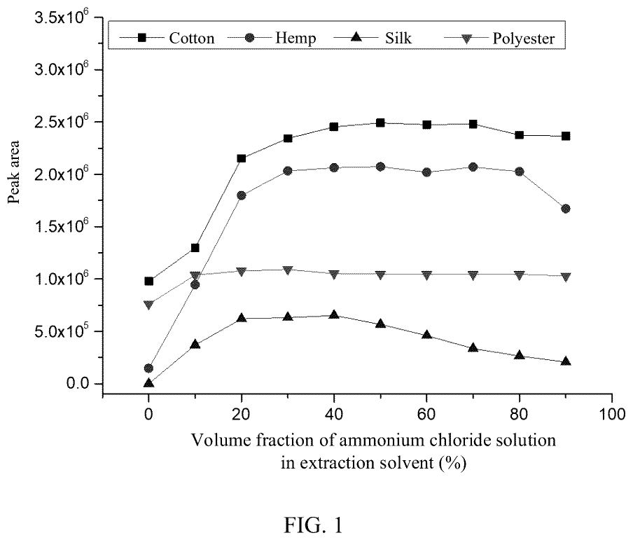

In the experiment, a hydrochloric acid solution is used first as an extraction solution. When the concentration of the hydrochloric acid solution is 2.0 mol/L, the extraction performance is optimal, and a good recovery rate can be achieved in a spiking-and-recovery experiment. However, after the extraction solvent is directly injected into the instrument, the baseline fluctuations are large, and spurious peaks are increased. Considering that the minimum pH value of the chromatographic column is 2.0, the PHMB content needs to be determined through the instrument after the pH value is adjusted using ammonia water. This procedure is cumbersome. Therefore, an ammonium chloride solution is chosen as an extraction solution in the experiment. Considering that 1 mol/L ammonium chloride solution is scarcely effective for extracting PHMB from the positive samples of silk, experiments are performed and the experiment results show that the performance of extracting PHMB from the positive samples of silk is significantly enhanced when a mixture of an ammonium chloride solution and methanol is used as an extraction solution. 0, 10, 20, 30, 40, 50, 60, 70, 80, and 90 mL of 1 mol/L ammonium chloride solutions (with the pH value adjusted to 2.2 using hydrochloric acid) are transferred to volumetric flasks separately, and are diluted to a volume of 100 mL with methanol separately, so as to obtain an ammonium-chloride-and-methanol extraction solution in which the volume fraction of the ammonium chloride is 0% to 90%, 20 mL of the extraction solution is taken to extract PHMB from 1 gram of the positive samples of cotton, hemp, silk, and polyester, separately. The extraction performance is shown in FIG. 1. FIG. 1 shows that for the positive samples of cotton, hemp, and silk, with the increase of the volume fraction of the ammonium chloride solution, the PHMB peak area initially increases, and then tends to reach equilibrium, and then decreases; for the positive samples of cotton, the extraction performance is optimal when the volume fraction of the ammonium chloride solution is 50%; for the positive samples of hemp and silk, the extraction performance is optimal when the volume fraction of the ammonium chloride solution is 40%. For the positive samples of polyester, when the volume fraction of the ammonium chloride solution increases from 0% to 30%, the peak area gradually increases, but further increasing the volume fraction to 90% does not result in a significant change in the peak area. After the impact of the volume fraction of the ammonium chloride solution in the ammonium-chloride solution-and-methanol extraction solution on the extraction of PHMB from the positive samples of cotton, hemp, silk, and polyester is considered comprehensively, the finally selected volume fraction of the ammonium chloride solution is 40%.

### 1.2.3 Impact of Concentration of Ammonium Chloride Solution in the Extraction Solution on Extraction Performance

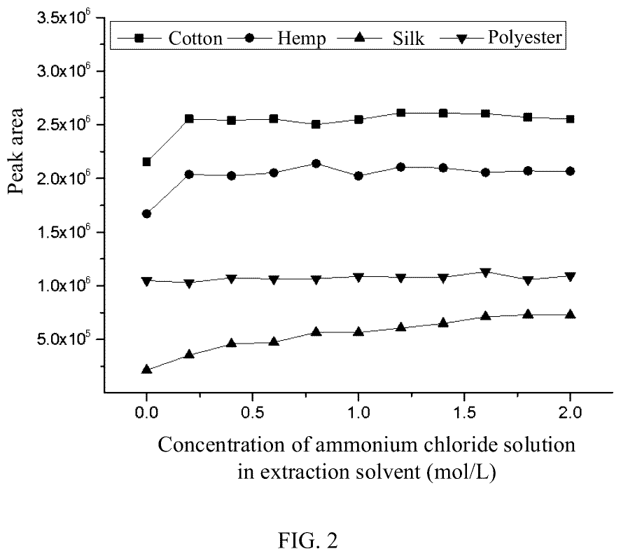

To investigate how the concentration of the ammonium chloride solution affects the performance of extracting PHMB from the positive samples, ammonium chloride solutions with concentrations of 0.0 mol/L, 0.2 mol/L, 0.4 mol/L, 0.6 mol/L, 0.8 mol/L, 1.0 mol/L, 1.2 mol/L, 1.4 mol/L, 1.6 mol/L, 1.8 mol/L, and 2.0 mol/L are prepared separately in an experiment. The pH value of the solutions is adjusted to 2.2 separately using hydrochloric acid. 40 mL of each of the solutions is transferred to a volumetric flask and diluted to a volume of 100 mL with methanol, so as to obtain an ammonium-chloride-solution-and-methanol extraction solution. FIG. 2 shows how the concentration of the ammonium chloride solution in the ammonium-chloride-solution-and-methanol extraction solution affects the performance of extraction from the positive samples. As can be seen from FIG. 2, for the positive samples of cotton and hemp, when the concentration of the ammonium chloride increases from 0.0 mol/L to 0.2 mol/L, the peak area of PHMB gradually increases, but further increasing the concentration of the ammonium chloride to 2.0 mol/L does not result in a significant change in the peak area of PHMB. For the positive samples of silk, when the concentration of the ammonium chloride increases from 0.0 mol/L to 1.8 mol/L, the peak area of PHMB gradually increases, but further increasing the concentration of the ammonium chloride to 2.0 mol/L does not result in a significant change in the peak area of PHMB. For the positive samples of polyester, when the concentration of the ammonium chloride increases from 0.0 mol/L to 2.0 mol/L, the peak area of PHMB does not significantly change. Therefore, the finally selected concentration of the ammonium chloride in the experiment is 1.8 mol/L.

### 1.2.4 Impact of the pH Value of Ammonium Chloride Solution in the Extraction Solution on Extraction Performance

Conventional extraction methods do not consider the impact of the pH value. However, after investigation, the applicant hereof finds that the pH value exerts an indefinite effect on the extraction performance. Therefore, under the optimal conditions described in Sections 1.2.2 and 1.2.3, the impact of the pH value of the ammonium chloride solution in the extraction solution on the performance of extracting PHMB from the positive samples is investigated.

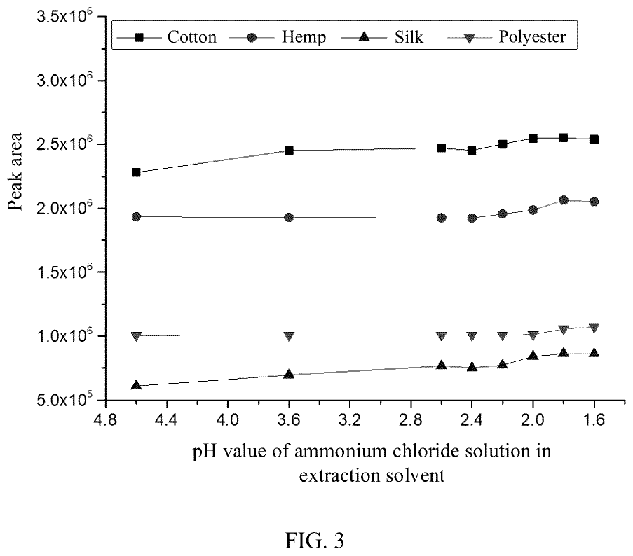

In the experiment, a 1.8 mol/L ammonium chloride solution is used, and the pH value of the solution is adjusted to 4.6, 3.6, 2.6, 2.4, 2.2, 2.0, 1.8, and 1.6 separately using hydrochloric acid. 40 mL of each of the solutions is transferred to a volumetric flask and diluted to a volume of 100 mL with methanol, so as to obtain an ammonium-chloride-solution-and-methanol extraction solution. FIG. 3 shows the performance of ammonium chloride solutions at different pH values in extracting PHMB from positive samples. As can be seen from FIG. 3, when the pH value of the ammonium chloride solution decreases from 4.6 to 3.6, the peak area of PHMB in the positive samples of cotton gradually increases, but further decreasing the pH value to 2.4 does not result in a significant change in the peak area of PHMB. When the pH value decreases from 2.4 to 2.0, the peak area of PHMB gradually increases again, but further decreasing the pH value does not result in a significant change in the peak area. When the pH value of the ammonium chloride decreases from 4.6 to 2.4, the peak area of PHMB in the positive samples of hemp does not change significantly. When the pH value decreases from 2.4 to 1.8, the peak area of PHMB gradually increases, but further decreasing the pH value does not result in a significant change in the peak area. When the pH value of the ammonium chloride decreases from 4.6 to 1.8, the peak area of PHMB in the positive samples of silk gradually increases, but further decreasing the pH value does not result in a significant change in the peak area. When the pH value of the ammonium chloride decreases from 4.6 to 2.0, the peak area of PHMB in the positive samples of polyester does not change significantly. When the pH value further decreases to 1.8, the peak area gradually increases, but further decreasing the pH value does not result in a significant change in the peak area of PHMB. This analysis indicates that the pH value exerts an impact on the extraction performance in this technique. Therefore, the finally selected pH value of the ammonium chloride solution in the experiment 1.8.

### 1.2.5 Final Selection of Extraction Solution

Based on the above experiments, a mixture of ammonium chloride solution and methanol is finally selected as an extraction solution, where the concentration of the ammonium chloride solution is 1.8 mol/L (with the pH value adjusted to 1.8 using hydrochloric acid), and the volume fraction of the ammonium chloride solution is 40%.

### (2) Selection of an Extraction Time

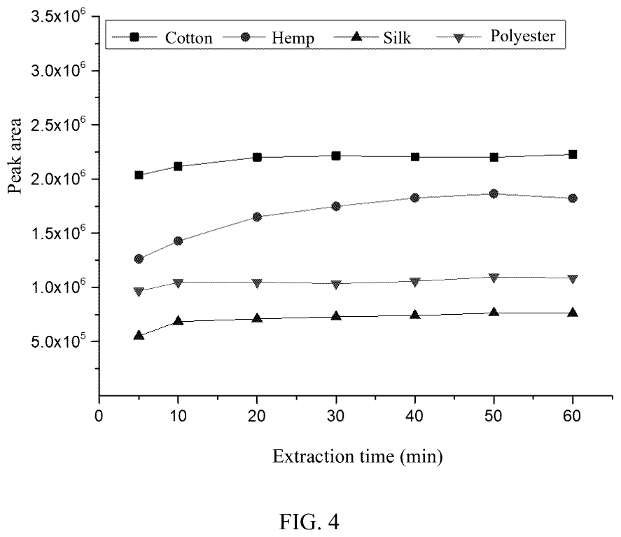

1.0 gram of positive samples of cotton, hemp, silk, and polyester are weighed out in series and placed in stoppered sealed glass extractors separately. 20 mL of extraction solution is added into each of the glass extractors. One-time ultrasonic extraction is performed at 50° C. to obtain an extracted liquid. The extracted liquid is filtered through a 0.45 μm polytetrafluoroethylene membrane, and then tested under the specified operating conditions of the instrument to investigate the impact caused by different extraction times on the extraction performance. The test results are shown in FIG. 4. As can be seen from FIG. 4, for positive samples of hemp and silk, the peak area of PHMB assumes a tendency to gradually increase with the increase of the extraction time. The peak area reaches a maximum at an extraction time of 50 minutes. Further increasing the extraction time does not result in a significant change in the peak area. For positive samples of cotton, the peak area of PHMB assumes a tendency to gradually increase when the extraction time increases from 5 min to 20 min, but further increasing the extraction time does not result in a significant change in the peak area. For positive samples of polyester, the peak area of PHMB assumes a tendency to gradually increase when the extraction time increases from 5 min to 10 min, but further increasing the extraction time does not result in a significant change in the peak area. Considered comprehensively, in view of the impact of the extraction time on the extraction yield alone, the optimal extraction time is 50 minutes.

### (3) Selection of an Extraction Temperature

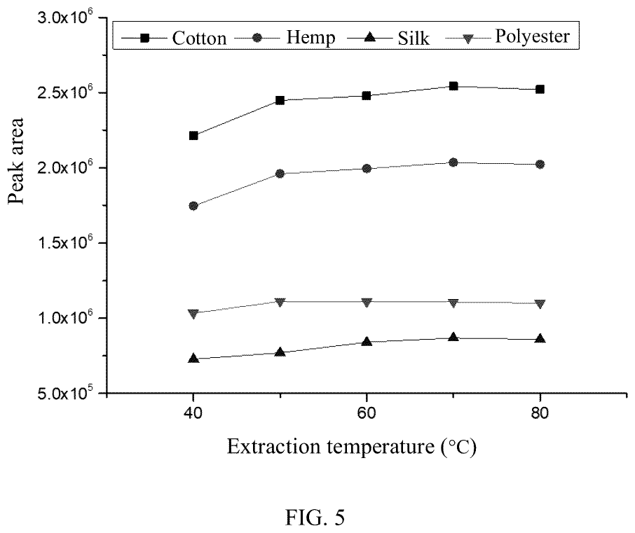

1.0 gram of positive samples of cotton, 1.0 gram of positive samples of hemp, 1.0 gram of positive samples of silk, and 1.0 gram of positive samples of polyester are weighed out and placed in stoppered sealed glass extractors separately. 20 mL of extraction solution is added into each of the glass extractors. The extraction time is set to 50 min to investigate the impact caused by different extraction temperatures on the extraction performance. The test results are shown in FIG. 5. As can be seen from FIG. 5, with the increase of the extraction temperature, the peak area of PHMB assumes a tendency to gradually increase. For positive samples of cotton, hemp, and silk, the peak area of PHMB reaches a maximum at an extraction temperature of 70° C. For positive samples of polyester, the peak area reaches a maximum at an extraction temperature of 50° C., and further increasing the extraction temperature does not result in a significant increase in the peak area. Considered comprehensively, in view of the impact of the extraction temperature on the extraction yield alone, the optimal extraction temperature is 70° C.

### (4) Selection of an Ultrasonic Extraction Volume

1.0 gram of positive samples (of cotton, hemp, silk, and polyester) in series are weighed out and placed in stoppered sealed glass extractors separately. 15 mL, 20 mL, 25 mL, and 30 mL of extraction solution are added into the glass extractors respectively. One-time ultrasonic extraction is performed at 70° C. for 50 minutes to obtain an extracted liquid. The extracted liquid is filtered through a 0.45 μm polytetrafluoroethylene membrane, and then tested under the specified operating conditions of the instrument. The test results are shown in Table 2. Table 2 shows that for positive samples of cotton and silk, the optimal extraction solvent volume is 20 mL; for positive samples of hemp, the optimal extraction solvent volume is 25 mL; for positive samples of polyester, the optimal extraction solvent volume is 15 mL. Considered comprehensively, when the extraction solvent volume is 20 mL, the performance of extracting PHMB from all the positive samples is superior. Therefore, 20 mL is selected as the optimal extraction solvent volume. The results are shown in Table 2.

TABLE 2
Impact of extraction solvent volume on performance
of extracting PHMB from positive samples

| Extraction solvent volume | Extraction yield (mg/g) | | | |
|---|---|---|---|---|
| (mL) | Cotton | Hemp | Silk | Polyester |
| 15 | 5.10 | 4.15 | 1.66 | 2.30 |
| 20 | 5.35 | 4.33 | 1.79 | 2.28 |
| 25 | 5.25 | 4.37 | 1.73 | 2.26 |
| 30 | 5.15 | 4.24 | 1.70 | 2.23 |

### (5) Selection of the Number of Times of Extractions

Positive samples of 4 materials-cotton, hemp, silk, and polyester are placed in 50 mL stoppered glass extractors separately. 20 mL of extraction solution is added into each of the glass extractors. The extraction temperature is 70° C., and the extraction time was 50 min. After each extraction operation, the extracted liquid is filtered through a 0.45 μm polytetrafluoroethylene membrane and then tested under the specified operating conditions of the instrument to determine the extraction yield in each extraction operation. A total extraction yield and a percentage of each extraction yield in the total extraction yield are calculated. The results are shown in Table 3. For positive samples of cotton, hemp, silk, and polyester, the 1^{st} extraction yield accounts for at least 92% of the total extraction yield. To improve the detection efficiency, a one-time ultrasonic extraction method is ultimately employed. The results are shown in Table 3.

TABLE 3
Experimental results of continuous ultrasonic extractions (mg/g)

| | | | 3# sample | |
|---|---|---|---|---|
| | 1# sample | 2# sample | (mulberry | 4# sample |
| Sample | (cotton) | (ramie) | silk) | (polyester) |
| 1^{st} extraction | 5.35 | 4.33 | 1.79 | 2.28 |
| yield (mg/kg) | | | | |
| 2^{st} extraction | 0.17 | 0.21 | 0.12 | 0.12 |
| yield (mg/kg) | | | | |
| 3^{st} extraction | 0.00 | 0.00 | 0.02 | 0.00 |
| yield (mg/kg) | | | | |
| Total extraction | 5.52 | 4.54 | 1.93 | 2.4 |
| yield (mg/kg) | | | | |
| Percentage of 1^{st} | 96.9 | 95.4 | 92.7 | 95.0 |
| extraction yield (%) | | | | |
| Percentage of 2^{st} | 3.1 | 4.6 | 6.2 | 5.0 |
| extraction yield (%) | | | | |
| Percentage of 3^{st} | 0.0 | 0.0 | 1.0 | 0.0 |
| extraction yield (%) | | | | |

### (6) Selection of a Filter Membrane

In the experiment, nylon filter membrane, polyethersulfone filter membrane, cellulose acetate filter membrane, and polytetrafluoroethylene filter membrane from different manufacturers are selected, and are tested using a 10 mg/L standard solution. The results show that most filter membranes adsorb PHMB, resulting in low recovery rates. Filter membranes of the same material from different manufacturers exhibit different effects of adsorbing PHMB. Through repeated experiments, it is found that the polytetrafluoroethylene filter membrane produced by Tianjin Jinteng Experiment Equipment Co., Ltd. exhibits the best recovery rate when filtering PHMB solutions. Therefore, the polytetrafluoroethylene filter membrane produced by Tianjin Jinteng is selected.

### (7) Confirmation of Final Extraction Conditions

In summary, the finally determined pretreatment conditions are as follows: taking a representative specimen, cutting the specimen into fragments of approximately 5 mm×5 mm in size, and mixing thoroughly. Weighing out 1.0 gram of the specimen accurately (accurate to the nearest 0.01 g), placing the specimens into a 50 mL stoppered glass extractor, adding 20 mL of extraction solution accurately, placing the solution in an ultrasonic extractor, and performing ultrasonic extraction at 70° C. for 50 minutes to obtain an extracted liquid. Cooling the extracted liquid to room temperature, filtering the extracted liquid through a 0.45 μm polytetrafluoroethylene membrane, and then performing a test under the specified operating conditions of the instrument. When necessary, performing appropriate dilution before analysis.

### 1.3 Optimization of Chromatographic Conditions

### (1) Selection of a Detection Wavelength

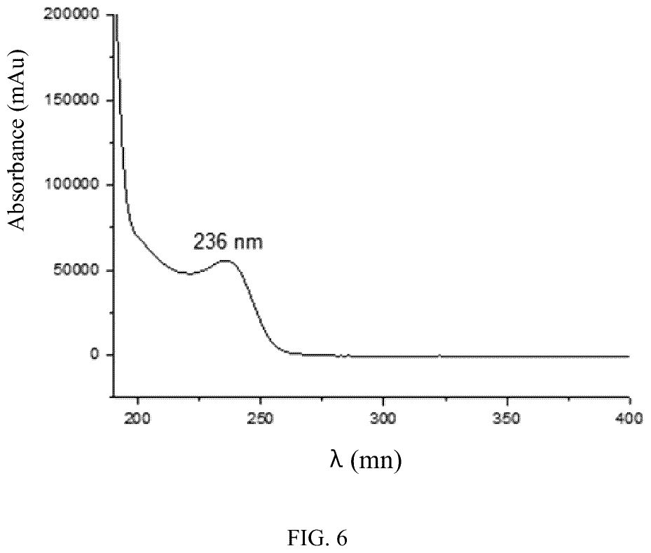

A UV-Vis spectrogram of a PHMB standard solution is tested, as shown in FIG. 6. Because 1 strong absorption peak is exhibited at 236 nm, the selected detection wavelength is 236 nm.

### (2) Selection of a Chromatographic Column

Literature shows that the main chromatographic columns used for high-performance liquid chromatography in the determination of PHMB are C18 liquid chromatographic column and cyano column. Therefore, in this experiment, C18 liquid chromatographic column and cyano column are preferred. As a result, it is found that, for the C18 liquid chromatographic columns of different specifications and models, either the peak elution time of the PHMB is earlier (the chromatographic peak of the PHMB emerges near the solvent peak) or a plurality of peaks emerge, thereby affecting the qualitative and quantitative analysis of the PHMB. When a cyano column is used as an analytical column, one PHMB chromatographic peak can be obtained by controlling the mobile-phase ratio and the pH value. In addition, many other liquid chromatographic columns such as phenyl column and amino column are also used for testing, but the test results are unsatisfactory. The experiment investigates cyano chromatographic columns of three different specifications (250 mm (column length)×4.6 mm (inner diameter)×5 μm (particle size), 150 mm (column length)×4.6 mm (inner diameter)×5 μm (particle size), and 75 mm (column length)×4.6 mm (inner diameter)×3.5 μm (particle size), and the elution behavior of the chromatographic peak is investigated by adjusting different mobile phases and mobile-phase ratios as well as the pH value. It is found that when a 250 mm chromatographic column is applied, the chromatographic peak shape is inferior; when a 150 mm or 75 mm chromatographic column is applied, a complete chromatographic peak can be obtained. A shorter column results in an earlier peak elution time. Comparison reveals that the PHMB chromatographic peak response value is relatively high when the 150 mm chromatographic column is applied. Therefore, a 150 mm (column length)×4.6 mm (inner diameter)×5 μm (particle size) cyano chromatographic column is finally selected as an analytical column in the experiment.

### (3) Selection of a Mobile Phase

In reversed-phase liquid chromatography, highly polar mobile phases such as water, methanol, and acetonitrile are typically used. In this experiment, methanol/water and acetonitrile/water are selected as mobile phases first, but the chromatographic peak of PHMB fails to be obtained. Literature reports the use of acetonitrile, water, and a 3 mmol/L hydrochloric acid solution as a mobile phase. Initially, the chromatographic column is flushed with acetonitrile and water to create a strong interaction between the guanidinium cation of PHMB and the polar bonded group in the cyano column. After the mobile phase transitions to an acetonitrile-hydrochloric acid solution, the ionization of PHMB is suppressed, and the strong binding force between the PHMB and the polar bonded group in the cyano column is weakened. As a result, 1 PHMB chromatographic peak is obtained. However, using the hydrochloric acid solution as a mobile phase may damage the metal components of the instrument. Therefore, this experiment uses an aqueous phosphoric acid solution (organic acid) instead of an inorganic acid solution to investigate the PHMB chromatographic peak characteristics exhibited when acetonitrile, water, and phosphoric acid solution is used as a mobile phase and when methanol, water, and aqueous phosphoric acid solution is used as a mobile phase. Experiments reveal that all the mobile phases above yield 1 PHMB chromatographic peak. When methanol, water, and aqueous phosphoric acid solution are used as a mobile phase, the column pressure is relatively high, and the baseline fluctuations are relatively large during mobile phase switching. Conversely, when acetonitrile, water, and phosphoric acid solution are used as a mobile phase, the column pressure is relatively low, and the baseline fluctuations are relatively small during mobile phase switching. Therefore, acetonitrile, water, and phosphoric acid solution are selected as a mobile phase in this experiment.

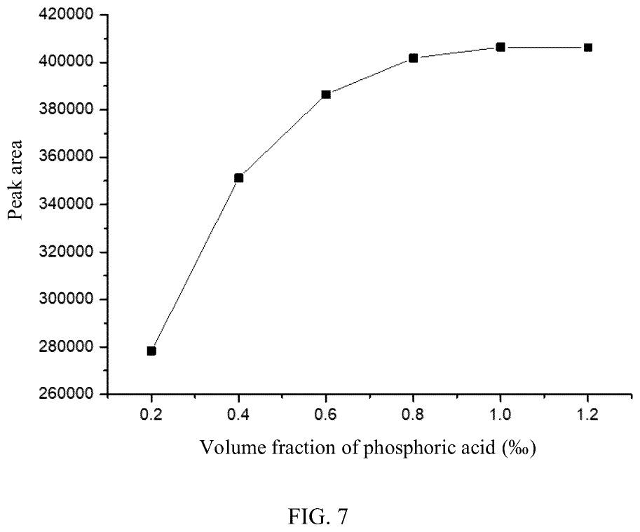

The impact of different volume fractions of aqueous phosphoric acid solution on the PHMB chromatographic peak is investigated. Aqueous phosphoric acid solutions with volume fractions of 0.2‰, 0.4‰, 0.6‰, 0.8‰, 1.0‰, and 1.2‰ are prepared as a mobile phase separately to investigate the change in the PHMB peak area, as specifically shown in FIG. 7. As can be seen from FIG. 7, the PHMB peak area gradually increases with the increase of the volume fraction of the phosphoric acid. When the volume fraction of the phosphoric acid reaches 1.0‰, the PHMB peak area reaches a maximum, and further increasing the volume fraction of the phosphoric acid does not result in a significant change in the PHMB peak area. Therefore, the selected volume fraction of the phosphoric acid is 1.0‰.

### (4) Selection of a Flow Rate

With all other chromatographic conditions remaining constant, the variable flow rate affects the retention time, peak area, resolution, and column pressure of the analyte. At a column temperature of 30° C., the retention time, peak area, resolution, and column pressure of PHMB at flow rates of 0.8 mL/min, 1.0 mL/min, 1.2 mL/min, and 1.5 mL/min are investigated separately. The experimental results show that at a flow rate of 1.0 mL/min, the column pressure is moderate, the peak area response is good, and the retention time and resolution fall within a reasonable range.

### (5) Selection of Column Temperature

After the flow rate is determined, the column temperature is changed to 25° C., 30° C., 35° C., 40° C., 45° C., and 50° C. separately. The experimental results show that, with the increase of the temperature, the overall peak area does not change significantly, but the column pressure keeps decreasing with the rise of the temperature. However, the retention time does not change significantly with the change of the column temperature. When the column temperature was 30° C., the column pressure is appropriate and the chromatographic peak shape of the target analyte is optimal. Therefore, 30° C. is selected as the column temperature.

### (6) Determination of Chromatographic Conditions

Under the conditions of a column temperature of 30° C. and a flow rate of 1.0 mL/min, a standard solution is subjected to gradient elution by varying the initial components of the mobile phase and the elution gradient, and the changes in the PHMB chromatographic peak are observed. The experimental results show that when the mobile phase follows the gradient program in Table 4, the analyte is best separated and eluted without being interfered with by impurities, with the signal intensity being relatively high. The mobile phases are defined as follows: mobile phase A: water; mobile phase B: 0.1% (v/v) aqueous phosphoric acid solution; and mobile phase C: acetonitrile.

TABLE 4
Gradient elution program of mobile phases

| | Mobile | Mobile | Mobile |
|---|---|---|---|
| Time | phase A | phase B | phase C |
| (min) | (%) | (%) | (%) |
| 0.00 | 94 | 1 | 5 |
| 1.00 | 94 | 1 | 5 |
| 1.01 | 59 | 1 | 40 |
| 12.00 | 59 | 1 | 40 |
| 12.01 | 0 | 60 | 40 |
| 20.00 | 0 | 60 | 40 |
| 20.01 | 94 | 1 | 5 |
| 27.00 | 94 | 1 | 5 |

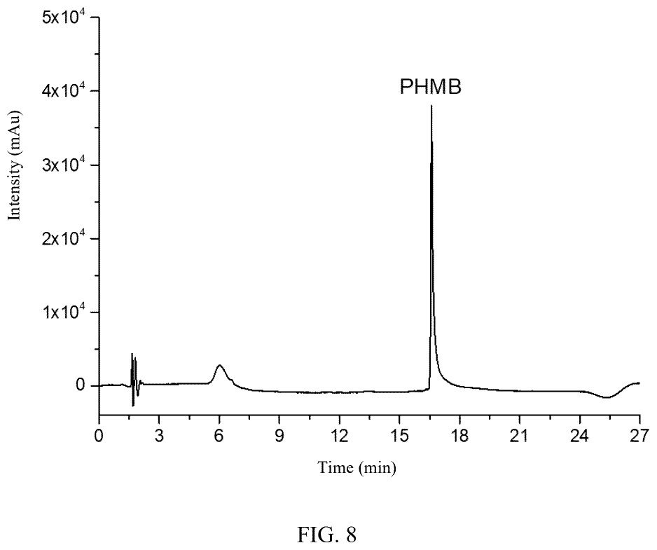

FIG. 8 is an HPLC chromatogram of a PHMB standard solution. The PHMB chromatographic peak in FIG. 8 is exhibited at the retention time t_{R}=16.523 min. The peak is sharp and symmetrical without being interfered with by impurities.

In this method, qualitative identification is based on the retention time of the chromatographic peak and confirmed using an ultraviolet absorption spectrum of the PHMB. Quantitative analysis is performed using an external standard quantitation method based on the peak area of the chromatographic peak.

Therefore, the finally determined chromatographic separation conditions are as follows: gradient elution using the mobile phase in Table 4; flow rate: 1.0 mL/min; and column temperature: 35° C., monitored with a DAD detector.

### Embodiment 2: Linear Range and Limit of Detection

Weighing out 0.1 gram of PHMB standard (exact value 0.1 g) accurately, and preparing a PHMB standard stock solution with a mass concentration of 10000 μg/mL using pure water. Transferring 1.0 mL of the PHMB standard stock solution accurately to a 10 mL volumetric flask, and diluting the solution to the mark with the extraction solution to obtain a standard intermediate solution with a mass concentration of 1000 μg/mL. Serially diluting the intermediate standard solution with the extraction solution to obtain a series of standard working solutions with mass concentrations of 10 μg/mL, 20 μg/mL, 50 μg/mL, 100 μg/mL, and 200 μg/mL separately. Testing the series of standard working solutions under optimal chromatographic conditions. Constructing a calibration curve by plotting the blank-corrected peak area versus the mass concentration of PHMB. The results show that, when the mass concentration is 10 to 200 μg/mL, the linear relationship is good, the linear equation is Y=9536.8x−710.13, and the linear correlation coefficient R²=0.9999. Calculating the limit of detection of the instrument based on a signal-to-noise ratio of 3 (S/N=3) to obtain a limit of detection of 60 mg/kg in this method. Calculating the limit of quantitation of the instrument based on a signal-to-noise ratio of 10 (S/N=10) to obtain a limit of quantitation of 200 mg/kg in this method.

### Embodiment 3: Recovery and Precision Tests

Accurately weighing out 1.0 gram of each of cotton, ramie, mulberry silk, and polyester containing no target compound. Spiking each of the weighed materials with 0.2 mg, 1.0 mg, and 2.0 mg of PHMB. Preparing 7 parallel samples for each spiking level. Testing the samples according to the method described above, and the test results are shown in Table 5. Calculating the average recovery rate in this method based on the data in Table 5, and the results are shown in Table 6. The average recovery rate of the PHMB is 90.1% to 100.0%, with a relative standard deviation being 1.09% to 4.31%.

TABLE 5
Spike recovery of PHMB in different textile matrices

| | Spiked | | | | | | | | | |
|---|---|---|---|---|---|---|---|---|---|---|
| | amount | Measured value (mg/L) | | | | | | | Mean | RSD |
| Sample | (mg) | 1 # | 2 # | 3 # | 4 # | 5 # | 6 # | 7 # | (mg) | (%) |
| Cotton | 0.2 | 0.173 | 0.179 | 0.185 | 0.19 | 0.187 | 0.182 | 0.194 | 0.184 | 3.81 |
| | 1.0 | 0.962 | 0.946 | 1.01 | 0.934 | 1.001 | 1.009 | 0.974 | 0.977 | 3.16 |
| | 2.0 | 2.02 | 2.007 | 1.977 | 1.944 | 1.987 | 2.061 | 1.969 | 1.995 | 1.92 |
| Hemp | 0.2 | 0.19 | 0.171 | 0.173 | 0.19 | 0.185 | 0.182 | 0.177 | 0.181 | 4.27 |
| | 1.0 | 0.906 | 0.987 | 1.002 | 0.955 | 0.937 | 1.004 | 0.953 | 0.963 | 3.76 |
| | 2.0 | 1.939 | 1.967 | 2.018 | 1.986 | 1.969 | 2.06 | 1.959 | 1.985 | 2.07 |
| Silk | 0.2 | 0.179 | 0.167 | 0.184 | 0.181 | 0.179 | 0.178 | 0.193 | 0.180 | 4.31 |
| | 1.0 | 0.903 | 0.955 | 0.966 | 0.912 | 0.982 | 0.974 | 0.926 | 0.945 | 3.33 |
| | 2.0 | 1.886 | 1.918 | 1.965 | 2.003 | 1.897 | 2.052 | 1.957 | 1.954 | 3.05 |
| Polyester | 0.2 | 0.174 | 0.183 | 0.189 | 0.193 | 0.19 | 0.177 | 0.176 | 0.183 | 4.18 |
| | 1.0 | 0.919 | 0.949 | 0.982 | 0.929 | 0.962 | 0.978 | 0.971 | 0.956 | 2.55 |
| | 2.0 | 2.009 | 1.988 | 2.014 | 1.972 | 2.037 | 1.994 | 1.984 | 2.000 | 1.09 |

TABLE 6
Recovery rate and precision of PHMB in different
textile matrices at various spiking levels

| | Spiked | | | | | | | | | |
|---|---|---|---|---|---|---|---|---|---|---|
| | amount | Recovery rate (%) | | | | | | | Mean | RSD |
| Sample | (mg) | 1 # | 2 # | 3 # | 4 # | 5 # | 6 # | 7 # | (%) | (%) |
| Cotton | 0.2 | 86.5 | 89.5 | 92.5 | 95.0 | 93.5 | 91.0 | 97.0 | 92.1 | 3.81 |
| | 1.0 | 96.2 | 94.6 | 101.0 | 93.4 | 100.1 | 100.9 | 97.4 | 97.7 | 3.16 |
| | 2.0 | 101.0 | 100.4 | 98.9 | 97.2 | 99.4 | 103.1 | 98.5 | 99.8 | 1.92 |
| Hemp | 0.2 | 95.0 | 85.5 | 86.5 | 95.0 | 92.5 | 91.0 | 88.5 | 90.6 | 4.27 |
| | 1.0 | 90.6 | 98.7 | 100.2 | 95.5 | 93.7 | 100.4 | 95.3 | 96.3 | 3.76 |
| | 2.0 | 97.0 | 98.4 | 100.9 | 99.3 | 98.5 | 103.0 | 98.0 | 99.3 | 2.07 |
| Silk | 0.2 | 89.5 | 83.5 | 92.0 | 90.5 | 89.5 | 89.0 | 96.5 | 90.1 | 4.31 |
| | 1.0 | 90.3 | 95.5 | 96.6 | 91.2 | 98.2 | 97.4 | 92.6 | 94.5 | 3.33 |
| | 2.0 | 94.3 | 95.9 | 98.3 | 100.2 | 94.9 | 102.6 | 97.9 | 97.7 | 3.05 |
| Polyester | 0.2 | 87.0 | 91.5 | 94.5 | 96.5 | 95.0 | 88.5 | 88.0 | 91.6 | 4.18 |
| | 1.0 | 91.9 | 94.9 | 98.2 | 92.9 | 96.2 | 97.8 | 97.1 | 95.6 | 2.55 |
| | 2.0 | 100.5 | 99.4 | 100.7 | 98.6 | 101.9 | 99.7 | 99.2 | 100.0 | 1.09 |

### Embodiment 4: Sample Detection

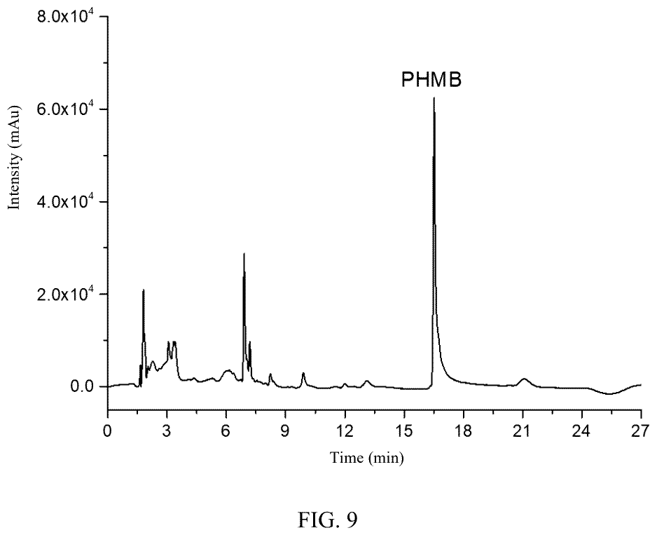

Commercial textiles, including underwear, underpants, socks, and sports masks, are tested using the method established herein. PHMB is detected at a content of 1.42 mg/g in the inner lining of one sports mask. FIG. 9 shows A high-performance liquid chromatogram of this positive sample.

### CONCLUSION

In summary, this method is simple and easy to operate. Experimental results show that the linear relationship, precision, and recovery rate in this method meet the requirements for qualitative and quantitative analysis, and this method can meet the needs of detecting PHMB in textiles.

The foregoing embodiments merely describe several implementations of this application. The description is relatively detailed, but constitutes no limitation on the patent scope hereof. It is hereby noted that several variations and improvements, which may be made to the embodiments by a person of ordinary skill in the art without departing from the concept of this application, fall within the protection scope of this application. Therefore, the protection scope of this application is subject to the claims appended hereto.

What is claimed is:

1. A method for detecting polyhexamethylene biguanide hydrochloride in textiles, characterized in that the method comprises the following steps:
(1) sample pretreatment: adding a textile under test into an extraction solvent, and performing ultrasonic extraction and filtration to obtain a sample test solution; and
(2) high-performance liquid chromatography detection: analyzing the sample test solution under the following chromatographic conditions to obtain a chromatogram, and determining a content of the polyhexamethylene biguanide hydrochloride in the textile through analytical chemistry calculation based on the chromatogram, wherein
in step (1), the extraction solvent comprises an ammonium chloride solution and methanol, a volume fraction of the ammonium chloride solution is 20% to 70%, a concentration of the ammonium chloride solution is 0.5 mol/L to 2.0 mol/L, and a pH value of the ammonium chloride solution is 1.5 to 4.0;
the chromatographic conditions in step (2) comprise:
chromatographic column: C18 liquid chromatographic column or cyano chromatographic column of 4.6×150 mm and 5 μm or 4.6×75 mm and 3.5 μm in size;
column temperature: 30° C. to 50° C.;
mobile phase A: water;
mobile phase B: aqueous phosphoric acid solution, with a volume fraction 0.1‰ to 1.2‰;
mobile phase C: acetonitrile; and
flow rate: 0.8 mL/min to 1.2 mL/min.

2. The method for detecting polyhexamethylene biguanide hydrochloride in textiles according to claim 1, characterized in that in step (1), the extraction solvent comprises the ammonium chloride solution and the methanol, the volume fraction of the ammonium chloride solution is 40%, the concentration of the ammonium chloride solution is 1.8 mol/L, the pH value of the ammonium chloride solution is 1.8, and a method for the analytical chemistry calculation in step (2) is external standard quantitation.

3. The method for detecting polyhexamethylene biguanide hydrochloride in textiles according to claim 1, characterized in that in step (1), the ultrasonic extraction is one-time ultrasonic extraction, and a linear equation of an external standard curve in the external standard quantitation is Y=9536.8x−710.13.

4. The method for detecting polyhexamethylene biguanide hydrochloride in textiles according to claim 1, characterized in that in step (1), a mass ratio of the textile under test to the extraction solvent is 1:(15 to 25), and the chromatographic conditions in step (2) comprise an elution gradient, and the elution gradient is as follows:
in a time segment from 0 min to 1 min, the elution gradient is: 94% for mobile phase A, 1% for mobile phase B, and 5% for mobile phase C;
in a time segment from 1 min to 12 min, the elution gradient is: 59% for mobile phase A, 1% for mobile phase B, and 40% for mobile phase C;
in a time segment from 12 min to 20 min, the elution gradient is: 0% for mobile phase A, 60% for mobile phase B, and 40% for mobile phase C;
in a time segment from 20 min to 27 min, the elution gradient is: 94% for mobile phase A, 1% for mobile phase B, and 5% for mobile phase C.

5. The method for detecting polyhexamethylene biguanide hydrochloride in textiles according to claim 3, characterized in that in step (1), an extraction time of the ultrasonic extraction is 40 min to 60 min, and concentration gradients for plotting the external standard curve are 10, 20, 50, 100, and 200 μg/mL.

6. The method for detecting polyhexamethylene biguanide hydrochloride in textiles according to claim 1, characterized in that in step (1), an extraction temperature of the ultrasonic extraction is 60° C. to 80° C., and the textile under test is one or more selected from cotton, hemp, silk, or polyester.

7. The method for detecting polyhexamethylene biguanide hydrochloride in textiles according to claim 1, characterized in that in step (1), a volume of an extraction solution for the ultrasonic extraction is 15 mL to 35 mL, the textile under test is one or more selected from natural fiber or artificial fiber, and dimensions of the textile under test is 5 mm×5 mm.

8. The method for detecting polyhexamethylene biguanide hydrochloride in textiles according to claim 1, characterized in that in step (1), a filter membrane used in the filtration is a polytetrafluoroethylene membrane with a pore size of 0.45 μm, and the textile under test is one or more selected from plant fiber or animal fiber.

9. The method for detecting polyhexamethylene biguanide hydrochloride in textiles according to claim 8, characterized in that the flow rate in step (2) is 1.0 mL/min.

10. The method for detecting polyhexamethylene biguanide hydrochloride in textiles according to claim 7, characterized in that the chromatographic column in step (2) is a cyano chromatographic column of 4.6×150 mm and 5 μm in size, and the textile under test in step (1) is polyester.
